(19) United States
(12) Patent Application Publication
(10) Pub. No.: US 2008/0309555 A1
(43) Pub. Date: Dec. 18, 2008

(54) METHOD FOR SETTING SMART ANTENNA AND SYSTEM THEREOF

(76) Inventors: Yung-Chi Fan, Taipei City (TW); Ming-Iu Lai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/138,449

(22) Filed: Jun. 13, 2008

(30) Foreign Application Priority Data
Jun. 14, 2007 (TW) 096121526

(51) Int. Cl. H01Q 3/00

(52) U.S. Cl. 342/372

(57) ABSTRACT

The invention provides a method for setting a smart antenna and a system thereof. The smart antenna has a plurality of antenna patterns and is used to communicate with at least a wireless communication device. The method includes the following steps. A plurality of connection quality test results of the wireless communication device corresponding to the antenna patterns are detected and stored periodically in turn. According to the connection quality test results, the optimal antenna configuration is determined. Then, the antenna is set according to the optimal antenna configuration when antenna needs to communicate with the wireless communication device to obtain the optimal communication quality.

### BACKGROUND OF THE INVENTION

1. Field of the Invention

The invention provides a method for setting a smart antenna and a system thereof which are applied to the wireless network and, more particularly, to a method for switching the patterns of the smart antenna dynamically to obtain the optimal communication quality and the system thereof.

2. Description of the Related Art

With the progress of the new generation wireless network technology IEEE 802.11a/b/g, the network bandwidth provided by it meets the demand for the audio and video in the digital home. However, in the practical household environment, since the wireless network stations are provided at different positions in the home, the transmitting process of the wireless signal is easily affected by the layout, wall, furniture and moving people in the home, and then the multi-path fading occurs. In addition, microwave oven or communication equipment using the same frequency band also interferes with the receiving performance of the stations, and then the audio and video data transmitted via the wireless network cannot keep stable, which troubles users enjoying the video program.

Conventionally, household wireless network uses omni-direction antenna design. Signals are transmitted toward surrounding by 360 degree with the antenna as the center. Thus, the radiation pattern cannot be adjusted for a specific station to obtain a preferred communication quality. Therefore, when the transmitting state of the network is unstable, the conventional method is using a low connection rate to transfer data to improve the anti-interference ability of the signals. Once one station encounters serious multi-path fading, or the connection quality is un-preferred because of interference caused by household appliances, the transmission rates of all the stations are turned down (such as from 54 Mbps to 24 Mbps). In this way, the connection rate actually used by the wireless network often is 24 Mbps or lower than 24 Mbps instead of commonly recognized 54 Mbps. Thus, the network bandwidth cannot be effectively used.

### BRIEF SUMMARY OF THE INVENTION

The invention provides a method for setting a smart antenna and a system thereof which are applied to the wireless network. The optimal antenna configuration of the antenna is determined according to the network environment and the station. The pattern of the smart antenna is set to be the optimal antenna configuration dynamically to improve the communication quality and reduce the multi-path fading or interference caused by other communication equipment. Thus, the wireless network may maintain a high transmission rate, and the network frequency band may be effectively used.

According to an embodiment of the invention, a method for determining an objective antenna configuration of an antenna is provided. The antenna has a plurality of antenna patterns and is used to communicate with at least a wireless communication device. The method includes the following steps. The connection quality of the wireless communication device corresponding to the antenna patterns is detected periodically in turn. The corresponding connection quality test results are stored. According to the connection quality test results, an objective connection quality test result is obtained. According to the antenna pattern that the objective connection quality test result corresponds to, the objective antenna configuration of the antenna is determined.

According to another embodiment of the invention, a system for determining an objective antenna configuration of an antenna is provided. The antenna has a plurality of antenna patterns and is used to communicate with at least a wireless communication device. The system includes an antenna controller, a state detector, a storage device and a processor. The state detector is used to detect the connection quality of the wireless communication device corresponding to the antenna patterns periodically in turn when the antenna and the wireless communication device transmit signals and stores the corresponding connection quality test results. The storage device is used to store a connection quality test result corresponding to the connection quality. The processor is coupled to the antenna controller, the state detector and the storage device, and the processor is used to obtain an objective connection quality test result according to the connection quality test results and to determine the objective antenna configuration according to the antenna pattern that the objective connection quality test result corresponds to.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an antenna system applied to a wireless network of an embodiment of the invention; and

FIG. 2 is a flow chart of determining the objective antenna configuration of the antenna of an embodiment of the invention.

### DETAILED DESCRIPTION OF THE EMBODIMENTS

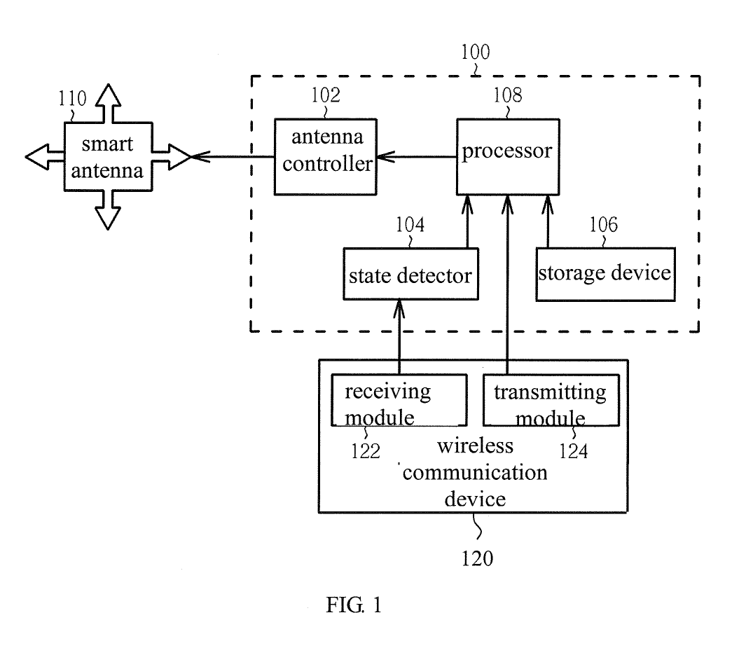

FIG. 1 is a schematic diagram showing an antenna system applied to a wireless network of an embodiment of the invention. The smart antenna is the antenna with a plurality of radiation patterns, and it has, for example, stronger signal transmission strength at a certain angle. In the embodiment, the smart antenna 110 is applied to an access point of a wireless network. The system 100 is used to determine an optimal antenna configuration (such as a most suitable pattern) of the smart antenna 110 corresponding to a wireless communication device 120. When the access point (not shown) needs to communicate with the wireless communication device 120, the antenna 110 is set by the optimal antenna configuration to obtain the expected communication quality. Therefore, the system 100 includes an antenna controller 102, a state detector 104, a storage device 106 and a processor 108. In the embodiment, the antenna controller 102 is in charge of initializing and setting work related to the hardware such as setting the hardware of the antenna 110, initializing the input/output interface of the access point and reading and writing.

When the system 100 begins to compute the optimal antenna configuration of the antenna 110 corresponding to the wireless communication device 120, the processor 108 sets the pattern of the antenna 110 to be a first antenna pattern of a plurality of antenna patterns supported by the antenna 110 via the antenna controller 102. Then, signals are transmitted between the set antenna 110 and the wireless communication device 120. At that moment, the state detector 104 detects the connection quality between the wireless communication device 120 and the access point, reads the connection quality test result from the receiving module 122 of the wireless communication device 120 and transmits the connection quality test result to the processor 108 to do follow-up processing. In the embodiment, the connection quality test result read by the state detector 104 includes received signal strength indicator (RSSI), signal transmission rate, signal receiving rate of the data and acknowledgement received by the access point and transmitted by the wireless communication device 120 and the number of times of error re-transmission which happens when the access point transmits data to the wireless communication device 120. After the test results are transmitted to the processor 108, they are stored in the storage device 106 via the processor 108, or the processor 108 analyzes the test results (for example, compute the average RSSI) and stores the analysis result in the storage device 106.

Afterward, the processor 108 sets the pattern of the antenna 110 to be the second antenna pattern via the antenna controller 102, and then signals are transmitted between the set antenna 110 and the wireless communication device 120. The state detector 104 reads the connection quality test result again and stores the connection quality test result in the storage device 106 via the processor 108. The above steps are repeated until the connection quality test result corresponding to each antenna pattern is detected and stored. Then, the processor 108 performs an optimum calculation according to a plurality of connection quality test results stored in the storage device 106 to obtain an optimal connection quality test result. According to the antenna pattern that the optimal connection quality test result corresponds to, the optimal antenna configuration of the antenna 110 is determined. Both of the optimal antenna configuration determined at last and the corresponding optimal connection quality test result are stored in the storage device 106. For example, the processor 108 performs an optimum algorithm to obtain a convergence value of each connection quality test result. Then, the convergence values are compared to obtain an optimal connection quality test result, and the antenna pattern that the optimal connection quality test result corresponds to is the optimal antenna configuration that the antenna 110 uses to communicate with the wireless communication device 120. The algorithm that the processor 108 uses is not limited, as long as the algorithm may be used to obtain an optimal connection quality test result from the connection quality test results, the algorithm may be applied in the invention.

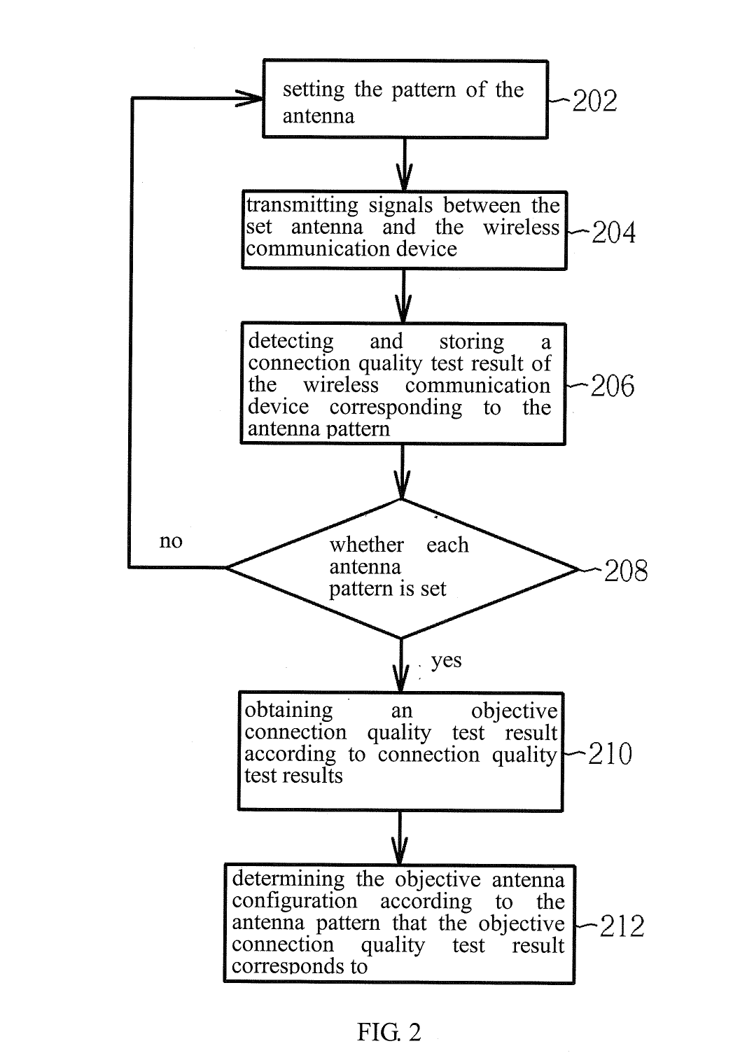

FIG. 2 is a flow chart showing the steps of determining the objective antenna configuration of the antenna 110. As shown in FIG. 2, the method of the embodiment includes the following steps.

In the step 202, the pattern of the antenna 110 is set to be one antenna pattern of the antenna patterns.

In the step 204, signals are transmitted between the set antenna 110 and the wireless communication device 120.

In the step 206, a connection quality of the wireless communication device 120 corresponding to the antenna pattern is detected, and a connection quality test result corresponding to the connection quality is stored.

In the step 208, whether each antenna pattern has been set is determined. If yes, the step 210 follows. If no, the step 202 follows, and the antenna 110 is set to be another antenna pattern.

In the step 210, an objective connection quality test result is obtained according to a plurality of connection quality test results.

In the step 212, the objective antenna configuration of the antenna 110 is determined according to the antenna pattern that the objective connection quality test result corresponds to.

As long as the same effect may be obtained, the steps of determining the objective antenna configuration may follow the flow path described hereinbefore imcompletely or may be performed un-successively. That is, other steps may be inserted into the above steps. In the step 202 to the step 208, the connection quality of the wireless communication device 120 corresponding to the antenna patterns of the antenna 110 is detected periodically in turn, and the corresponding connection quality test results are stored.

In addition, to conveniently illustrate the steps of setting the antenna 110, only one wireless communication device 120 is shown in the embodiment and FIG. 1. However, the invention is not limited in one wireless communication device. That is, the antenna 110 also may be used to communicate with a plurality of wireless communication devices. Thus, in the step 204, the set antenna is used to communicate with the wireless communication devices. In the step 206, the connection quality test result of each wireless communication device corresponding to the antenna pattern is detected periodically in turn and stored. Since the data read from the wireless communication device is the media assess control (MAC) layer address indicating the wireless communication device, the system 100 may recognize the wireless communication device which the detected data which is a connection quality test result belongs to and store it in the storage device 106. In the step 210, aiming at each wireless communication device, according to a plurality of connection quality test results corresponding to the antenna patterns, an objective connection quality test result is computed. In the step 212, according to the antenna pattern that the objective connection quality test result computed in the step 210 corresponds to, the objective antenna configuration of the antenna 110 used to communicate with the wireless communication device is determined.

Therefore, when a plurality of wireless communication devices exist in the covering range of the antenna 110, the antenna pattern having the optimal communication quality when the antenna 110 communicates with each wireless communication device is found out. The settings (including the optimal antenna configurations, the connection quality test results that the optimal antenna configurations correspond to, the network addresses and so on) may be stored as an antenna configuration list. After the antenna configuration list is finished, the state of system 100 transforms to an operating state from a setting state. When the access point needs to communicate with any wireless communication device of the wireless communication devices, the processor 108 selects an optimal antenna configuration corresponding to the wireless communication device from the antenna configuration list to set the pattern of the antenna 110. Thus, an optimum antenna setting may be provided for different receiving terminal to obtain optimal communication quality and decrease the multi-path fading and interference caused by other communication device. Thus, the wireless network may maintain high transmission rate to effectively utilize the network bandwidth.

When signals are transmitted between the access point and the wireless communication device 120, the state detector 104 may continuously monitor the connection quality between the wireless communication device 120 and the access point to generate a connection quality detection result. The connection quality detection result is transmitted to the processor 108 and is compared with the optimal connection quality test result. According to the comparison result, whether to re-perform the above steps to renew the optimal antenna configuration of the antenna 110 corresponding to the wireless communication device is determined. For example, when the state detector 104 detects that the transmission rate between the access point and the wireless communication device 120 is abnormal, or the number of the times of the error re-transmission greatly increases, it means that the environment of the wireless network is changed, and the previous set optimal antenna configuration is unsuitable. Therefore, the system 100 re-executes the setting program to find out the antenna configuration which is most suitable for the current network environment. The newest optimal antenna configuration renews the antenna configuration list stored in the storage device 106.

In addition, when it is detected that the location of the wireless communication device 120 is changed, another wireless communication device is provided in the covering range of the antenna 110, or a wireless communication device leaves the covering range, the system 100 also re-executes the above setting program to obtain the current optimal antenna configuration and renew the antenna configuration list. For example, by comparing the RSSI between the wireless communication device 120 and the antenna 110 with the average RSSI, whether the wireless communication device 120 is changed may be determined. If the current RSSI changes greatly relatively to the average RSSI, it means the position of the wireless communication device 120 may be changed. It is just a determining method provided by the embodiment, the methods that the people having ordinary skills may easily think of after they read the embodiment also are within the scope of the invention. In addition, the system 100 may re-execute setting program for the wireless communication devices in the covering range of the antenna 110, or the system 100 may renew the optimal antenna configuration for the moved or new added specific wireless communication device, which is determined according to the need of the user.

The system 100 may be integrated with the communication device (such as an access point) that the antenna 110 is applied to, may be integrated with the wireless communication device 120 or may be a control medium independent of the antenna 110 and the access point. The invention is not limited to be implemented by software or hardware, as long as the control for the smart antenna is provided at the back end of the network system. In addition, users further may establish a command parser to inspect the operating state of the system, or the processor 108 may be selectively switched on or switched off via the command parser according to the need. For example, if the system 100 is integrated in the wireless communication device 120 or is an independent control medium, and the antenna used by the network system is an omni-direction antenna (or not antenna having a plurality of antenna patterns), users may switched off the antenna setting. Therefore, the invention has elasticity in use.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for determining an objective antenna configuration of an antenna, wherein the antenna has a plurality of antenna patterns and is used to communicate with at least a wireless communication device, the method comprising the steps of:
detecting connection quality of the wireless communication device corresponding to the antenna patterns periodically in turn and storing corresponding connection quality test results;
obtaining an objective connection quality test result according to the connection quality test results; and
determining the objective antenna configuration of the antenna according to the antenna pattern that the objective connection quality test result corresponds to.

2. The method according to claim 1, wherein each of the connection quality test results comprises a received signal strength indicator (RSSI), a signal transmission rate, a signal receiving rate or a number of times of error re-transmission and is stored in an antenna configuration list.

3. The method according to claim 1, wherein the step of obtaining the objective connection quality test result according to the connection quality test results comprises the steps of:
computing a plurality of convergence values that the connection quality test results correspond to; and
comparing the convergence values to obtain the objective connection quality test result according to the connection quality test results.

4. The method according to claim 1, further comprising the steps of:
setting the antenna pattern according to the objective antenna configuration and detecting connection quality between the wireless communication device and the antenna to generate a connection quality detection result;
comparing the connection quality detection result with the objective connection quality test result to obtain a comparison result; and
determining whether the objective antenna configuration needs to be redetermined according to the comparison result.

5. The method according to claim 1 further comprising the step of:
redetermined the objective antenna configuration when it is detected that the wireless communication device is moved or another wireless communication device enters into the covering range of the antenna.

6. The method according to claim 5, wherein the step of detecting the connection quality of the wireless communication device corresponding to the antenna patterns periodically in turn and storing the corresponding connection quality test results further comprises the steps of computing and storing the average received signal strength indicator (RSSI) of the antenna patterns and detecting whether the wireless communication device is moved, the method comprising the steps of:
detecting a RSSI between the wireless communication device and the antenna;
comparing the RSSI and a average RSSI of the pattern corresponding to the objective antenna configuration to obtain a comparison result; and
determining whether the wireless communication device is moved according to the comparison result.

7. A system for determining an objective antenna configuration of an antenna, wherein the antenna has a plurality of antenna patterns and is used to communicate with at least a wireless communication device, the system comprising:
an antenna controller;
a state detector used for detecting connection quality of the wireless communication device corresponding to the antenna patterns periodically in turn when signals are transmitted between the antenna and the wireless communication device and storing corresponding connection quality test results;
a storage device for storing a connection quality test result corresponding to the connection quality; and
a processor coupled to the antenna controller, the state detector and the storage device and used for obtaining an objective connection quality test result according to the connection quality test results and determining the objective antenna configuration of the antenna according to the antenna pattern that the objective connection quality test result corresponds to.

8. The system according to claim 7, wherein the connection quality parameter comprises a received signal strength indicator (RSSI), a signal transmission rate, a signal receiving rate or the number of times of the error re-transmission and is stored in an antenna configuration list.

9. The system according to claim 7, wherein the processor computes a plurality of convergence values that the connection quality test results correspond to and compares the convergence values to obtain the objective connection quality test result according to the connection quality test results.

10. The system according to claim 7, wherein the processor further controls the antenna controller to set the pattern of the antenna according to the objective antenna configuration, the state detector further detects connection quality between the wireless communication device and the antenna after the antenna controller sets the pattern of the antenna according to the objective antenna configuration to generate a connection quality detection result, and the processor further compares the connection quality detection result and the objective connection quality test result to obtain a comparison result and determines whether to redetermine the objective antenna configuration according to the comparison result.

11. The system according to claim 7, wherein when the processor detects that the wireless communication device is moved or another wireless communication device is added into the covering range of the antenna, the objective antenna configuration is redetermined.

12. The system according to claim 11, wherein when the state detector detects the connection quality of the wireless communication device corresponding to the antenna patterns, the state detector detects a received signal strength indicator (RSSI), the processor computes the average RSSI of the wireless communication device corresponding to the antenna patterns according to the detected RSSI and stores the average RSSI in the storage device; when it is detected that the wireless communication device is moved, the processors obtains a comparison result by comparing the a RSSI detected by the state detector and the average RSSI corresponding to the pattern of the objective antenna configuration and determines whether the wireless communication device is moved according to the comparison result.
